(19) United States
(12) Patent Application Publication
(10) Pub. No.: US 2020/0057633 A1
(43) Pub. Date: Feb. 20, 2020

(54) BUILDING AND DEPLOYING BINARY ARTIFACTS

(71) Applicant: Microsoft Technology Licensing, LLC, Redmond, WA (US)

(72) Inventors: Sajid S. Topiwala, Santa Clara, CA (US); Szczepan M. Faber, Santa Clara, CA (US); Bill S. Lin, Sunnyvale, CA (US); Prasad S. Karkera, Union City, CA (US); Mihir J. Gandhi, Sunnyvale, CA (US); Pritesh V. Shah, Fremont, CA (US)

(73) Assignee: Microsoft Technology Licensing, LLC, Redmond, WA (US)

(21) Appl. No.: 16/105,636

(22) Filed: Aug. 20, 2018

(51) Int. Cl. G06F 8/71; G06F 8/41

(52) U.S. Cl. CPC G06F 8/71; G06F 8/433

(57) ABSTRACT

The disclosed embodiments provide a system for efficiently building and deploying binary artifacts. During operation, the system retrieves a first package containing a binary artifact from the repository. Next, the system uses metadata for the binary artifact to identify additional binary artifacts that include the dependencies. The system then retrieves, based on a local availability of the additional binary artifacts, the additional binary artifacts according to a procedure for expediting retrieval of the additional binary artifacts from files that are external to the first package. Finally, the system deploys the binary artifact and the dependencies from the second package into an environment.

### BACKGROUND

### Field

The disclosed embodiments relate to binary artifacts. More specifically, the disclosed embodiments relate to techniques for efficiently building and deploying binary artifacts.

### Related Art

Increasing sophistication and functionality in software modules are typically accompanied by corresponding increases in code size and complexity. For example, the addition of new features to an application or service may require the implementation and/or use of new or additional packages or libraries, which in turn increases the number of dependencies within the software program.

Increased size and complexity of software modules may further increase overhead in building, storing, and deploying the software modules. First, large amounts of comparatively slow disk input/output (I/O) operations may be required to build a software module into a deployable artifact that contains all libraries and/or packages on which the software module depends. Second, the larger size of the artifact may increase network bandwidth and/or latency during uploading of the artifact to a centralized and/or distributed binary repository and/or deployment of the artifact from the binary repository to a remote location. Third, additional storage resources may be utilized to accommodate redundant packaging of the same dependencies with multiple versions of the software module in the binary repository.

Consequently, development and use of software modules may be improved by increasing the efficiency associated with building, storing, managing, and/or deploying the software modules.

### BRIEF DESCRIPTION OF THE FIGURES

FIG. 1 shows a schematic of a system in accordance with the disclosed embodiments.

FIG. 2 shows a system for managing binary artifacts in accordance with the disclosed embodiments.

FIG. 3 shows a flowchart illustrating a process of managing a binary artifact in a repository in accordance with the disclosed embodiments.

FIG. 4 shows a flowchart illustrating a process of deploying a binary artifact in an environment in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The disclosed embodiments provide a method, apparatus, and system for efficiently building and deploying binary artifacts. Each binary artifact includes an executable and/or deployable form of a software module such as an application or service. Each binary artifact may be packaged with metadata that describes and/or identifies dependencies of the binary artifact instead of executable and/or deployable versions of the dependencies. The binary artifact and dependencies may be stored in separate files in a repository for subsequent deployment to one or more remote environments.

During deployment of a binary artifact to a remote environment, the packaged binary artifact may be downloaded from the repository, and metadata for the binary artifact in the package may be used to identify the dependencies of the binary artifact. A procedure for expediting retrieval of additional binary artifacts that contain the dependencies may then be determined based on the availability of the additional binary artifacts in a local cache. For example, the procedure may include retrieval of a first subset of the dependencies from the local cache and a second subset of the dependencies from the repository. If the number of dependencies to be retrieved from the repository exceeds a threshold, the procedure may additionally include batch retrieval of those dependencies from the remote repository. The binary artifact may then be repackaged with the dependencies for subsequent deployment of the binary artifact and dependencies into the environment.

Because initial packaging of the binary artifact omits the dependencies, the packaged binary artifact may require fewer storage resources, network bandwidth, and/or disk input/output (I/O) to build, store, and/or deploy than conventional binary artifacts that are packaged with the corresponding dependencies. At the same time, contextual caching and/or batch retrieval of the binary artifact and/or dependencies may reduce overhead associated with repackaging the binary artifacts with the dependencies prior to deploying the binary artifacts into various remote environments. Consequently, the disclosed embodiments may improve the performance and efficiency of computer systems and technologies related to building, storing, managing, and deploying software artifacts.

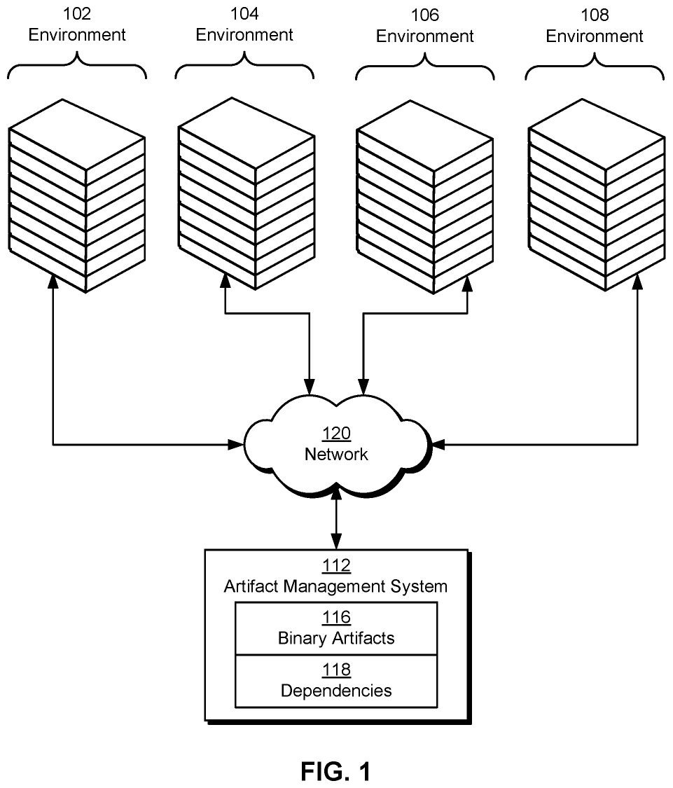

FIG. 1 shows a schematic of a system in accordance with the disclosed embodiments. As shown in FIG. 1, the system may include an artifact management system 112 that manages the assembly and deployment of software modules represented by a number of binary artifacts 116 and dependencies 118 of binary artifacts 116. Binary artifacts 116 may include deployable and/or executable forms of applications, processes, and/or services represented by the software modules, and dependencies 118 may include libraries, functions, and/or packages that are called or used by binary artifacts 116.

More specifically, artifact management system 112 may be used to centrally manage the building, storing, and deploying of the software modules into a number of remote environments 102-108. First, artifact management system 112 may build executable forms of binary artifacts 116 and/or dependencies 118 into archive and/or package formats. Next, artifact management system 112 may store the archives and/or packages in one or more repositories.

Artifact management system 112 may then transmit the software packages over a network 120 to a number of environments 102-108. For example, environments 102-108 may include clusters, data centers, cloud computing systems, collocation systems, development environments, integration environments, testing environments, staging environments, production environments, and/or other collections of physical and/or virtual machines. Environments 102-108 may be connected to one another and/or deployment system 112 over a local area network (LAN), wide area network (WAN), personal area network (PAN), virtual private network, intranet, mobile phone network (e.g., a cellular network), WiFi network, Bluetooth network, universal serial bus (USB) network, Ethernet network, switch fabric, and/or other type of network 120.

Finally, artifact management system 112 may use the software packages to deploy the software modules in environments 102-108. For example, artifact management system 112 may include a client that is installed in environments 102-108. The client may deploy a software module by retrieving a package containing the corresponding binary artifact and/or dependencies from a repository provided by artifact management system 112, using the package to install the software module in the environment, and/or executing the software module in the environment.

Those skilled in the art will appreciate that conventional binary artifacts are commonly packaged with all dependencies into a single archive or package. As a result, dependencies that are shared by different versions of the binary artifact and/or different binary artifacts may be duplicated in deployable packages for the binary artifacts. Such duplication of dependencies across packaged binary artifacts may increase disk I/O during building of the packages, network bandwidth required to transfer the packages to and from the repository, and/or hardware resources used to store the packages in the repository.

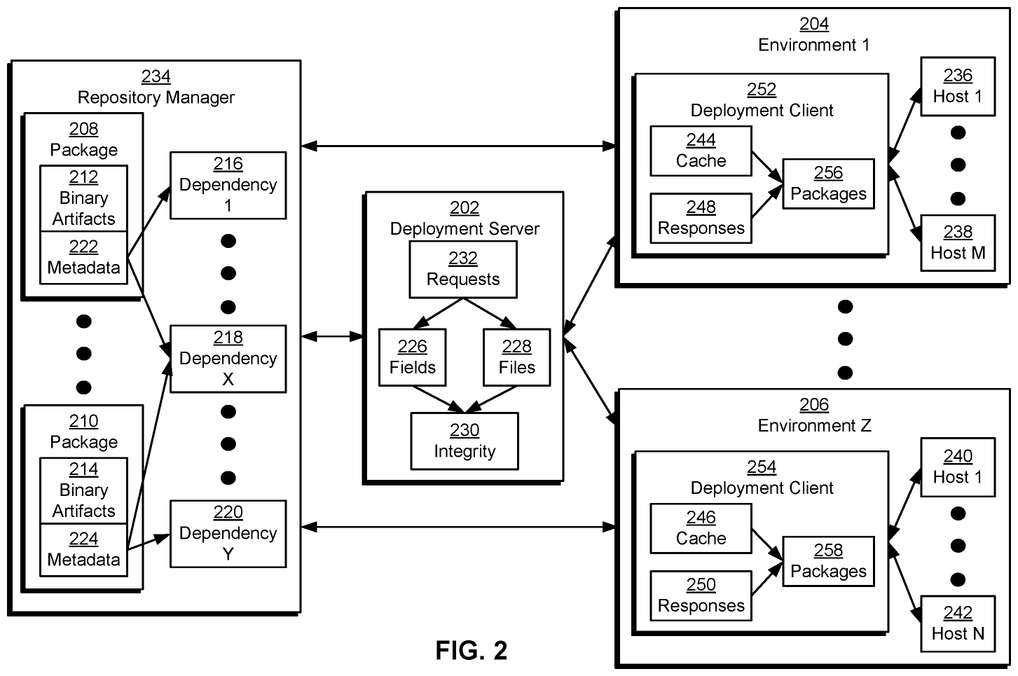

In one or more embodiments, artifact management system 112 includes functionality to increase the efficiency associated with building, storing, managing, and/or deploying binary artifacts 116 in environments 102-108. As shown in FIG. 2, a system for managing binary artifacts (e.g., artifact management system 112 of FIG. 1) includes a repository manager 234, a deployment server 202, and a number of deployment clients 252-254 executing in environments (e.g., environment 1 204, environment z 206) that are remote to repository manager 234 and/or deployment server 202.

Repository manager 234 performs centralized management of binary artifacts 212-214 and/or packages 208-210 containing binary artifacts 212-214 for a given team, project, organization, and/or other entity involved in developing software modules represented by the binary artifacts and/or packages. For example, repository manager 234 may build the software modules and corresponding dependencies (e.g., dependency 1 216, dependency x 218, dependency y 220) into deployable and/or executable binary artifacts 212-214 and/or packages 208-210; store binary artifacts 212-214 and/or packages 208-210 in local and/or remote repositories; and/or use metadata 222-224 to track and manage changes to and/or versions of binary artifacts 212-214 and/or packages 208-210. In another example, one or more instances of repository manager 234 and/or another component may build binary artifacts 212-214 and/or packages 208-210 before uploading the built binary artifacts 212-214 and/or packages 208-210 into a centralized repository.

Deployment server 202 interacts with repository manager 234 and/or deployment clients 252-254 to deploy software modules represented by the binary artifacts and/or packages in the corresponding environments. For example, deployment clients 252-254 may issue requests 232 for deployable packages 208-210 to deployment server 202. In response to requests 232, deployment server 202 may use parameters of requests 232 to retrieve files 228 containing the corresponding packages 208-210 from one or more repositories provided by repository manager 234. Deployment server 202 may additionally use fields 226 in metadata 222-224 for the requested files 228 to verify an integrity 230 of the corresponding packages 208-210 before returning files 228 in responses 248-250 to requests 232. Finally, deployment clients 252-254 may deploy the software modules from the returned files 228 to a number of physical or virtual hosts in the corresponding environments (e.g., host 1 236, host m 238 in environment 1 204, host 1 240, host n 242 in environment z 206).

In one or more embodiments, the system of FIG. 2 reduces latency, network bandwidth, and/or storage overhead associated with building, storing, and/or deploying binary artifacts by packaging the binary artifacts without the corresponding dependencies. In particular, repository manager 234 assembles packages 208-210 containing binary artifacts 212-214 without including dependencies of binary artifacts 212-214 in packages 208-210. Instead, repository manager 234 maintains and stores the dependencies in other files, binary artifacts, and/or packages that are separate from packages 208-210 and includes, in packages 208-210, metadata 222-224 that can be used to identify, locate, and verify the corresponding dependencies in the other files, binary artifacts, and/or packages.

As illustrated in FIG. 2, package 208 includes binary artifacts 212 and metadata 222 for binary artifacts 212, and package 210 includes binary artifacts 214 and metadata 224 for binary artifacts 214. Metadata 222 specifies one set of dependencies (e.g., dependency 1 216, dependency y 218) for binary artifacts 212, and metadata 224 specifies a different set of dependencies (e.g., dependency x 218, dependency y 220) for binary artifacts 214. Metadata 222-224 may further indicate that binary artifacts 212-214 have overlapping dependencies (e.g., dependency x 218).

An example representation of metadata (e.g., metadata 222-224) that is packaged with one or more binary artifacts (e.g., binary artifacts 212-214) by repository manager 234 may include the following:

```
{
  “dependencies”: [
    {
      “sha1”:“0a2c77a0ef7ac1e00aef169e248812ff72a8c2a7”,
      “file”: “open-replicator-impl-4.0.21.jar”,
      “destination”: “lib”,
      “type”: “jar”,
      “location”: “com.dds-mysql:open-replicator-impl:4.0.21”
    },
    {
      “sha1”: “2533a050540b62bf19dbd9ea124d8f43bdb3dd12”,
      “file”: “espresso-client-rich-impl-22.0.22.jar”,
      “destination”: “lib”,
      “type”: “jar”,
      “location”: “com.espresso-pub:espresso-client-rich-impl:22.0.22”
    },
    ...
  ]
}
```

The above representation describes two “dependencies” of the binary artifact(s). Each dependency is identified and/or defined using a different set of fields. Each set of fields includes a “sha1” field that contains a hash value (e.g., Secure Hash Algorithm 1 (SHA-1) hash) computed from the corresponding file, a “file” field that specifies a name of the file, and/or a “destination” field that can optionally be used to rename files with the same name and/or version number. Each set of fields further includes a “type” of the corresponding file (e.g., a Java archive (JAR) file) and a “location” of the corresponding file (e.g., a directory and/or path containing the file).

As a result, the metadata may allow the dependencies to be uniquely identified, located, and/or used with the corresponding binary artifacts without requiring the dependencies to be packaged with the binary artifacts. In turn, separation of the dependencies from packages 208-210 containing the corresponding binary artifacts 212-214 may allow repository manager 234 to maintain and/or store a single copy of each library, function, and/or package on which binary artifacts 212-214 depend instead of redundantly packaging multiple copies of a given dependency with all binary artifacts that have the dependency.

To deploy a given software module in an environment, one or more instances of a deployment client (e.g., deployment clients 252-254) in the environment may request a package containing the corresponding binary artifacts (e.g., binary artifacts 212-214) from deployment server 202 and/or repository manager 234. After the package is received, the deployment client may parse metadata (e.g., metadata 222-224) in the package to identify dependencies of the binary artifacts.

The deployment client may then determine a procedure for expediting retrieval of the dependencies from files that are external to the package. In particular, the deployment client may search a local cache (e.g., caches 244-246) for the dependencies; if a dependency is found in the local cache, the deployment client retrieves the dependency from the local cache. The deployment client may also select a method for retrieving remaining dependencies from deployment server 202 and/or repository manager 234 based on the number of remaining dependencies. For example, the deployment client may request batch retrieval of the remaining dependencies from deployment server 202 if the number of remaining dependencies exceeds a threshold. Conversely, the deployment client may transmit multiple requests 232 for individual dependencies to deployment server 202 if the number of remaining dependencies falls below the threshold.

Deployment server 202 may process requests 232 from the deployment client by retrieving files 228 matching the parameters of requests 232 (e.g., file names, locations, file types, etc.) from repository manager 234 and/or one or more repositories identified or provided by repository manager 234. Next, deployment server 202 may use the parameters and/or fields 226 in metadata (e.g., metadata 222-224) associated with files 228 to verify integrity 230 of files 228.

For example, the parameters and/or fields 226 may include hashes, checksums, and/or other values for verifying integrity 230 of packages 208-210 and/or the corresponding dependencies. To ensure that files 228 match the original versions of the packages and/or dependencies (instead of old, new, or overwritten versions), deployment server 202 may fetch files 228 by the hashes and/or checksums from the repositories and/or repository manager 234 and/or verify that hashes and/or checksums calculated from files 228 match the corresponding metadata fields 226 and/or request parameters. Deployment server 202 and/or repository manager 234 may also, or instead, ensure integrity 230 of files 228 by locking files 228 in the repositories.

After integrity 230 is verified for files 228 matching parameters of requests 232, deployment server 202 may return files 228 in one or more responses (e.g., responses 248-250) to requests 232. For example, deployment server 202 may process a request for batch retrieval of some or all dependencies by batching the corresponding files 228 into a single archive file and transmitting the archive file in a response to the request. In another example, deployment server 202 may process each request for an individual file by returning the file in a response to the request.

After the deployment client has retrieved all dependencies of the binary artifacts from the local caches and/or deployment server 202, the deployment client may assemble the binary artifacts and dependencies into a deployable package (e.g., packages 256-258). For example, the deployment client may aggregate the binary artifacts and dependencies into one or more archive files. If two or more files to be aggregated into an archive file contain identical file names, the deployment client may use fields 226 from metadata for the binary artifacts to rename the files prior to creating the archive file.

Prior to assembling the deployable package, the deployment client may verify integrity 230 of the binary artifacts and/or dependencies retrieved from the local cache and/or deployment server 202. For example, the deployment client may ensure that hashes, checksums, and/or other values calculated from the binary artifacts and/or associated dependencies match the corresponding fields in metadata for the binary artifacts.

After the deployable package is created, the deployment client may deploy the binary artifacts and dependencies from the package into the corresponding environment. For example, one or more instances of the deployment client may use the package to copy, install, and/or run the binary artifacts and/or dependencies in the environment. The instance(s) may also store the package in one or more local caches and use the stored package to deploy the binary artifacts and dependencies to multiple hosts in the environment, thus avoiding repackaging of the binary artifacts with the dependencies prior to deploying the binary artifacts to each of the hosts.

To expedite subsequent deployments of other binary artifacts and/or software modules in the environment, the deployment client may also store files 228 containing the dependencies in the local cache for a pre-specified period. For example, the deployment client may maintain a file containing a library and/or other dependency in the local cache for a fixed period (e.g., a number of hours, days, weeks, etc.), discard files in the local cache on a least recently used (LRU) basis, and/or add or remove files from the local cache according to another caching technique. In turn, the cached files may be used to build subsequent deployable packages for other binary artifacts in lieu of retrieving the files from deployment server 202 and/or repository manager 234.

By omitting dependencies from packages containing binary artifacts until the packages are used to deploy software modules to environments, the system may require fewer storage resources, network bandwidth, and/or disk input/output (I/O) to build, store, transmit, and/or deploy the packages than conventional techniques that package binary artifacts with the corresponding dependencies in binary repositories. At the same time, contextual caching and/or batch retrieval of the binary artifacts and/or dependencies may reduce overhead associated with repackaging the binary artifacts with the dependencies prior to deploying the binary artifacts into the environments. Consequently, the disclosed embodiments may improve the performance and efficiency of computer systems, network and storage resources, and technologies related to building, storing, managing, and deploying software artifacts.

Those skilled in the art will appreciate that the system of FIG. 2 may be implemented in a variety of ways. First, deployment server 202, deployment clients 252-254, and repository manager 234 may be provided by a single physical machine, multiple computer systems, one or more virtual machines, a grid, one or more databases, one or more filesystems, and/or a cloud computing system. Deployment server 202, deployment clients 252-254, and repository manager 234 may additionally be implemented together and/or separately by one or more hardware and/or software components and/or layers.

Second, one or more instances of deployment server 202, deployment clients 252-254, and repository manager 234 may be executed to accommodate requirements or limitations associated with scalability of the system and/or deployment of software modules across a number of environments and/or hosts. For example, a separate instance of a deployment client may execute on each host of a cluster and/or other environment into which a software module is to be deployed. The deployment client may use one or more copies of a cache (e.g., caches 244-246) in the environment and/or interact with one or more instances of deployment server 202 and/or repository manager 234 to retrieve dependencies of the software module prior to deploying the software module into the environment. Each copy of the cache may be located on a host and/or in a proxy for repository manager 234 in the environment.

Third, packages 208-210 and 256-258, binary artifacts 212-214, metadata 222-224, and/or dependencies may be created stored, defined, and/or transmitted using a number of techniques. For example, repository manager 234 may store packages 208-210, binary artifacts 212-214, metadata 222-224, and/or dependencies in different types of repositories, including relational databases, data warehouses, distributed filesystems, streams, online data stores, and/or flat files. In another example, the system may generate, store, and/or transmit metadata 222-224 in a number of formats, including database records, property lists, Extensible Markup language (XML) documents, JavaScript Object Notation (JSON) objects, and/or other types of structured data. In a third example, binary artifacts 212-214, packages 208-210 and 256-258, and/or dependencies may be adapted to file, package, and/or archive formats supported by the languages, platforms, and/or libraries used to develop and/or implement the corresponding software modules.

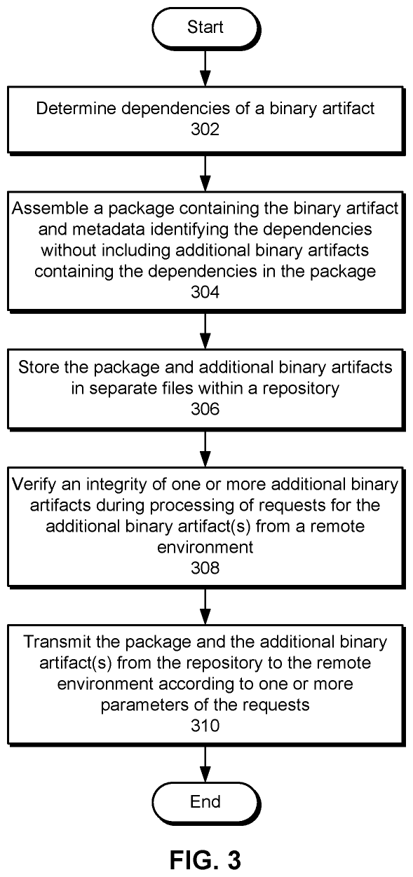

FIG. 3 shows a flowchart illustrating a process of managing a binary artifact in a repository in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, dependencies of the binary artifact are determined (operation 302). For example, the dependencies may include libraries, functions, and/or packages that are identified from declarations and/or calls in the binary artifact, metadata associated with the binary artifact, and/or metadata associated with the dependencies.

Next, a package containing the binary artifact and metadata identifying the dependencies is assembled without including additional binary artifacts containing the dependencies in the package (operation 304). For example, the package may be an archive that contains the binary artifact and a file with the metadata. The metadata may include names, renaming conventions, locations, types, hashes, checksums, and/or other fields that are used to identify and/or use the dependencies with the binary artifact.

The package and additional binary artifacts are then stored in separate files within a repository (operation 306). For example, the package and each dependency of the binary artifact may be stored in a separate file in the repository.

An integrity of one or more additional binary artifacts is also verified during processing of requests for the additional binary artifact(s) from a remote environment (operation 308). For example, the integrity of the additional binary artifacts may be verified by locking the corresponding files and/or using hashes, checksums, and/or other fields in the corresponding metadata.

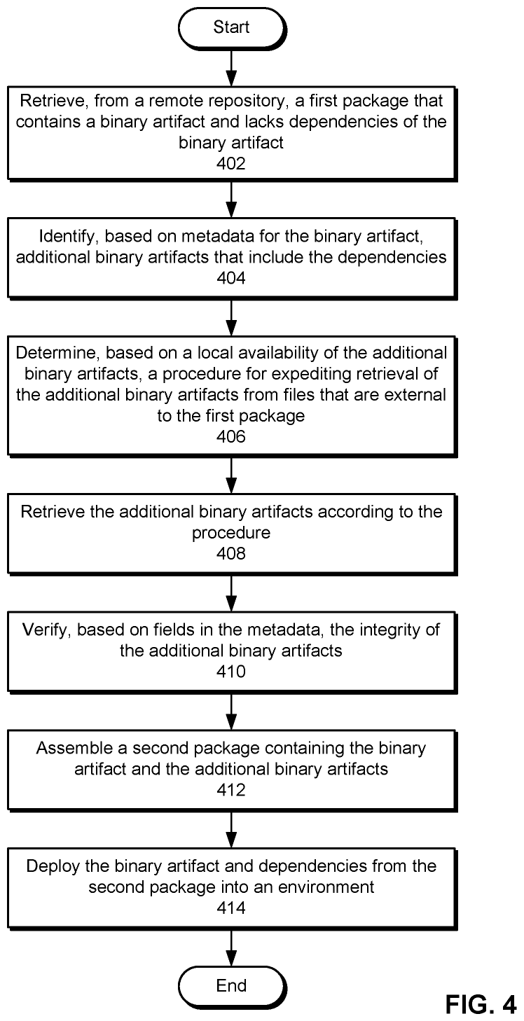

Finally, the package and additional binary artifact(s) are transmitted from the repository to the remote environment according to one or more parameters of the requests (operation 310). For example, transmission of some or all of the additional binary artifacts may be batched based on a request to perform batch retrieval of the additional binary artifacts from the repository to the remote environment. In another example, the additional binary artifacts may be transmitted in individual responses to multiple requests when each request is used to retrieve a separate binary artifact from the repository. After the package and additional binary artifact(s) are transmitted to the remote environment, the package and additional binary artifact(s) may be used to deploy the binary artifact and dependencies in the remote environment, as described in further detail below with respect to FIG. 4.

FIG. 4 shows a flowchart illustrating a process of deploying a binary artifact in an environment in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a first package that contains a binary artifact and lacks dependencies of the binary artifact is retrieved from a remote repository (operation 402). For example, the first package may include a binary artifact representing a deployable and/or executable form of a software module and a file containing metadata for the binary artifact.

Next, additional binary artifacts that include the dependencies are identified based on metadata for the binary artifact (operation 404). For example, the metadata may be obtained from the file in the first package, and names and locations of the additional binary artifacts may be identified from fields in the metadata.

A procedure for expediting retrieval of the additional binary artifacts from files that are external to the first package is then determined based on a local availability of the binary artifacts (operation 406). For example, the procedure may include retrieval of a first subset of additional binary artifacts from a local cache and a second subset of additional binary artifacts from the remote repository. In another example, the procedure may include batch retrieval of a number of additional binary artifacts from the remote repository when the number exceeds a threshold.

The additional binary artifacts are retrieved according to the procedure (operation 408), and the integrity of the additional binary artifacts is verified based on fields in the metadata (operation 410). For example, the additional binary artifacts may be retrieved from the local cache and/or remote repository by checksums, hashes, and/or other fields in the metadata. In another example, the checksums, hashes, and/or other attributes of the additional binary artifacts may be verified to match the corresponding metadata fields after the additional binary artifacts are retrieved.

Finally, a second package containing the binary artifact and the additional binary artifacts is assembled (operation 412), and the binary artifact and dependencies are deployed from the second package into an environment (operation 414). For example, the second package may include an archive that includes the binary artifact and all dependencies. The second package may be stored in the local cache, and the stored package may be used to deploy the binary artifact and dependencies to multiple hosts in the environment without repackaging the binary artifact and dependencies for each of the hosts. The additional binary artifacts containing the dependencies may also be stored in the local cache for a pre-specified period to expedite deployments of subsequent binary artifacts in the environment.

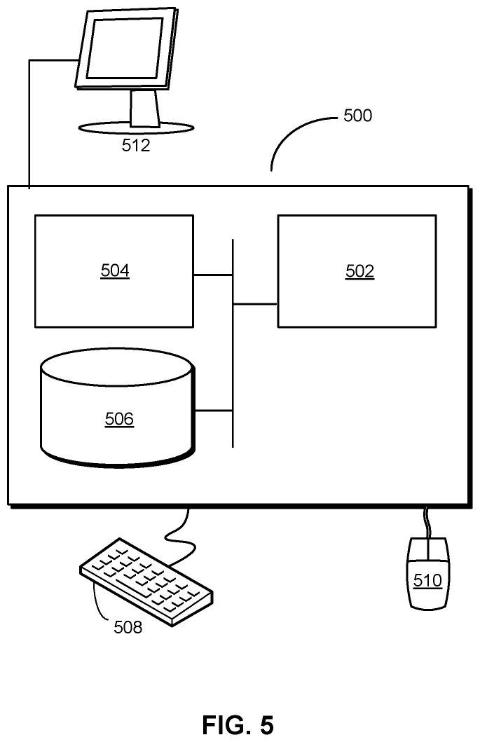

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for efficiently building and deploying binary artifacts. The system includes a repository manager, a deployment server, and a deployment client, one or more of which may alternatively be termed or implemented as a module, apparatus, plug-in, or other type of system component. The repository manager determines dependencies of a binary artifact and assembles a package containing the binary artifact and metadata identifying the dependencies without including additional binary artifacts containing the dependencies in the package. The repository manager also stores the package and the additional binary artifacts in separate files within a repository.

The deployment server verifies the integrity of the additional binary artifacts during processing of requests for the additional binary artifacts from a remote environment. The deployment server also transmits the package and the additional binary artifacts from the repository to the remote environment according to one or more parameters of the requests.

The deployment client retrieves a first package containing a binary artifact from the repository. Next, the deployment client uses metadata for the binary artifact to identify additional binary artifacts that include the dependencies. The deployment client then determines, based on a local availability of the additional binary artifacts, a procedure for expediting retrieval of the additional binary artifacts from files that are external to the first package. The deployment client also retrieves the additional binary artifacts according to the procedure and assembles a second package containing the binary artifact and the additional binary artifacts. Finally, the deployment client deploys the binary artifact and the dependencies from the second package into an environment.

In addition, one or more components of computer system 500 may be remotely located and connected to the other components over a network. Portions of the present embodiments (e.g., repository manager, deployment server, deployment client, environments, artifact management system, etc.) may also be located on different nodes of a distributed system that implements the embodiments. For example, the present embodiments may be implemented using a cloud computing system that builds, stores, manages, and/or deploys binary artifacts and dependencies in a set of remote environments.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
retrieving, from a remote repository, a first package comprising a binary artifact, wherein the first package lacks dependencies of the binary artifact;
identifying, by one or more computer systems based on metadata for the binary artifact, additional binary artifacts that comprise the dependencies;
retrieving, by the one or more computer systems based on a local availability of the additional binary artifacts, the additional binary artifacts according to a procedure for expediting retrieval of the additional binary artifacts from files that are external to the first package;
assembling a second package comprising the binary artifact and the additional binary artifacts; and
deploying the binary artifact and the dependencies from the second package into an environment.

2. The method of claim 1, further comprising:
verifying, based on a set of fields in the metadata, an integrity of the additional binary artifacts prior to assembling the second package.

3. The method of claim 2, wherein verifying the integrity of the additional binary artifacts comprises at least one of:
retrieving the additional binary artifacts by the set of fields; and
verifying that attributes of the additional binary artifacts match the set of fields after the additional binary artifacts are retrieved.

4. The method of claim 2, wherein the one or more fields comprise at least one of:
a hash; and
a checksum.

5. The method of claim 1, wherein identifying the additional binary artifacts that comprise the dependencies comprises:
obtaining the metadata from a file in the first package; and
identifying names and locations of the additional binary artifacts from fields in the metadata.

6. The method of claim 1, wherein determining the procedure for expediting retrieval of the additional binary artifacts from the locations that are external to the binary artifact comprises:
selecting, for the procedure, retrieval of a first subset of the additional binary artifacts from a local cache and a second subset of the additional binary artifacts from the remote repository.

7. The method of claim 1, wherein determining the procedure for expediting retrieval of the additional binary artifacts from the locations that are external to the binary artifact comprises:
selecting, for the procedure, batch retrieval of a number of the additional binary artifacts from the remote repository when the number exceeds a threshold.

8. The method of claim 1, wherein deploying the binary artifact and the dependencies from the second package into the environment comprises:
storing the second package in a local cache in the environment; and
deploying the binary artifact from the stored package in the local cache to a set of hosts in the environment without repackaging the binary artifact with the additional binary artifacts for each host in the set of hosts.

9. The method of claim 1, further comprising:
storing the additional binary artifacts in a local cache for a pre-specified period.

10. The method of claim 1, wherein the additional binary artifacts comprise an external library that is called by the binary artifact.

11. A method, comprising:
determining, by one or more computer systems, dependencies of a binary artifact;
assembling, by the one or more computer systems, a package comprising the binary artifact and metadata identifying the dependencies without including additional binary artifacts comprising the dependencies in the package;
storing the package and the additional binary artifacts in separate files within a repository;
verifying, by the one or more computer systems, an integrity of one or more of the additional binary artifacts during processing of requests for the one or more of the additional binary artifacts from a remote environment; and
transmitting the package and the one or more of the additional binary artifacts from the repository to the remote environment according to one or more parameters of the requests.

12. The method of claim 11, wherein transmitting the package and the one or more of the additional binary artifacts from the repository to the remote environment according to one or more parameters of the requests comprises:
batching transmission of a number of the additional binary artifacts based on a request from the remote environment to retrieve the number of the additional binary artifacts.

13. The method of claim 11, wherein transmitting the package and the one or more of the additional binary artifacts from the repository to the remote environment according to one or more parameters of the requests comprises:
transmitting the one or more of the additional binary artifacts in individual responses to the requests.

14. The method of claim 11, wherein the integrity of the additional binary artifacts is verified using a set of fields in the metadata.

15. The method of claim 14, wherein the set of fields comprises at least one of:
a hash; and
a checksum.

16. The method of claim 11, wherein the integrity of the additional binary artifacts is verified by locking the separate files.

17. The method of claim 11, wherein the metadata comprises at least one of:
names of the additional binary artifacts;
locations of the additional binary artifacts; and
types of the additional binary artifacts.

18. The method of claim 11, wherein the additional binary artifacts comprise an external library that is called by the binary artifact.

19. A non-transitory computer-readable storage medium storing instructions that when executed by a computer cause the computer to perform a method, the method comprising:
retrieving, from a remote repository, a first package comprising a binary artifact, wherein the first package lacks dependencies of the binary artifact;
identifying, based on metadata for the binary artifact, additional binary artifacts that comprise the dependencies;
retrieving, based on a local availability of the additional binary artifacts, the additional binary artifacts according to a procedure for expediting retrieval of the additional binary artifacts from files that are external to the first package;
producing a second package comprising the binary artifact and the additional binary artifacts; and
deploying the binary artifact and the dependencies from the second package into an environment.

20. The non-transitory computer-readable medium of claim 19, wherein determining the procedure for expediting retrieval of the additional binary artifacts from the files that are external to the first package comprises at least one of:
selecting, for the procedure, retrieval of a first subset of the additional binary artifacts from a local cache and a second subset of the additional binary artifacts from the remote repository; and
selecting, for the procedure, batch retrieval of a number of the additional binary artifacts from the remote repository when the number exceeds a threshold.
